(19) United States
(12) Patent Application Publication
(10) Pub. No.: US 2025/0309304 A1
(43) Pub. Date: Oct. 2, 2025

(54) POWER GENERATION CELL

(71) Applicant: Honda Motor Co., Ltd., Tokyo (JP)

(72) Inventor: Takaaki Shikano, Saitama (JP)

(21) Appl. No.: 19/063,233

(22) Filed: Feb. 25, 2025

(30) Foreign Application Priority Data
Mar. 29, 2024 (JP) 2024-058113

(51) Int. Cl. H01M 8/1004; H01M 4/86; H01M 8/0258; H01M 8/10

(52) U.S. Cl. CPC H01M 8/1004; H01M 4/8605; H01M 4/8657; H01M 8/0258; H01M 2008/1095

(57) ABSTRACT

A power generation cell including a membrane electrode assembly disposed to cover an opening of a frame, and a first and second separators disposed facing the membrane electrode assembly. The membrane electrode assembly includes an electrolyte membrane, first and second electrode catalyst layers, and first and second gas diffusion layers. The first separator includes first ribs to form partition walls for flow paths for first gas, the second separator includes second ribs to form partition walls for flow paths for second gas having lower pressure than the first gas, an end of the first gas diffusion layer along the first gas is positioned on an inner side closer to center of the opening, compared to an end of the second gas diffusion layer along the second gas, and is positioned on the inner side of ends of the plurality of second ribs.

### CROSS-REFERENCE TO RELATED APPLICATION

This application is based upon and claims the benefit of priority from Japanese Patent Application No. 2024-058113 filed on Mar. 29, 2024, the content of which is incorporated herein by reference.

### BACKGROUND OF THE INVENTION

### Field of the Invention

This invention relates to a power generation cell of a fuel cell.

### Description of the Related Art

In recent years, technological developments have been made on a fuel cell that contribute to energy efficiency in order to ensure access to energy that is affordable, reliable, sustainable and advanced by more people. As a technology for conveying a power generation cell used in this type of fuel cell, there is a known technique in which a resin frame member is sandwiched between the gas diffusion layer of the anode electrode and the gas diffusion layer of the cathode electrode, which are sandwiched between a pair of separators. Such an technology is described, for example, in Japanese Examined Patent Publication No. 6843730 (JP 6843730 B). In the power generation cell described in JP 6843730 B, the end of the gas diffusion layer is arranged in the flow path between the separator and the frame member.

Incidentally, when a fuel cell is used in a low-temperature environment, ice may adhere to the end of the gas diffusion layer after the operation of the fuel cell is completed. When the fuel cell is started in this state, the frame member may bend due to the differential pressure of the gas, and part of the membrane electrode assembly may peel off along with the ice.

### SUMMARY OF THE INVENTION

An aspect of the present invention is a power generation cell including a membrane electrode structure including a membrane electrode assembly, and a frame member provided with an opening covered by the membrane electrode assembly and supporting a peripheral edge portion of the membrane electrode assembly, and a first separator and a second separator disposed facing a first surface and a second surface on an opposite side of the first surface of the membrane electrode structure, respectively. The membrane electrode assembly includes an electrolyte membrane, a first electrode catalyst layer and a second electrode catalyst layer disposed in close contact with one surface and another surface of the electrolyte membrane, respectively, and a first gas diffusion layer and a second gas diffusion layer disposed between the first electrode catalyst layer and the first separator and between the second electrode catalyst layer and the second separator, the first separator includes a plurality of first ribs protruding toward the membrane electrode assembly and extending substantially parallel to each other, the plurality of ribs forming partition walls for a plurality of power generation flow paths for a first gas, the second separator includes a plurality of second ribs protruding toward the membrane electrode assembly and extending substantially parallel to each other, the plurality of ribs forming partition walls for a plurality of power generation flow paths for a second gas having a lower pressure than the first gas, and an end of the first gas diffusion layer along a flow direction of the first gas is positioned on an inner side closer to a center of the opening, compared to an end of the second gas diffusion layer along a flow direction of the second gas, and is positioned on the inner side of ends of the plurality of second ribs.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack having a power generation cell according to an embodiment of the present invention;

FIG. 2 is a cross-sectional view taken along line II-II in FIG. 1;

FIG. 3 is a perspective view showing a schematic configuration of the unitized electrode assembly included in the fuel cell stack of FIG. 1;

FIG. 4 is a front view of the separator included in the fuel cell stack in FIG. 1;

FIG. 5 is an enlarged view of a part V in FIG. 4;

FIG. 6A is a cross-sectional view illustrating a configuration of a main part of the power generation cell according to the embodiment of the present invention;

FIG. 6B is a diagram illustrating a state where a differential pressure acts on the power generation cell in FIG. 6A;

FIG. 7A is a diagram illustrating a reference example of FIG. 6A;

FIG. 7B is a diagram illustrating a state where a differential pressure acts on the power generation cell in FIG. 7A;

FIG. 8 is a diagram illustrating a modification of FIG. 6A;

FIG. 9A is a diagram illustrating another modification of FIG. 6A; and

FIG. 9B is a diagram illustrating a further modification of FIG. 6A.

### DETAILED DESCRIPTION OF THE INVENTION

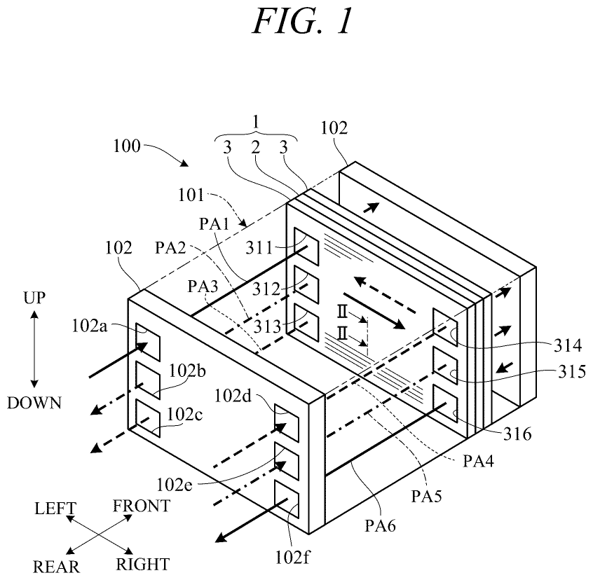

Hereinafter, an embodiment of the present invention will be described with reference to FIGS. 1 to 9B. A power generation cell according to an embodiment of the present invention is included in a fuel cell stack that is a main component of a fuel cell. The fuel cell is mounted on, for example, a vehicle and can generate electric power for driving the vehicle. First, the overall configuration of the fuel cell stack will be described schematically. The fuel cell stack may simply be referred to as a fuel cell.

FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each part will be described according to such definitions. These directions may be different from a front-rear direction, a left-right direction, and an up-down direction of the vehicle. The front-rear direction in FIG. 1 is a stacking direction of the fuel cell stack 100.

As shown in FIG. 1, the fuel cell stack 100 has a cell stacked body 101 formed by stacking a plurality of power generation cells 1 in the front-rear direction, and end units 102 arranged at both front and rear ends of the cell stacked body 101, and the whole of the fuel cell stack 100 has a substantially rectangular parallelepiped shape. The length of the cell stacked body 101 in the left-right direction is longer than its length in the up-down direction. For convenience, a single power generation cell 1 is shown in FIG. 1.

The power generation cell 1 has a unitized electrode assembly (hereinafter, referred to as a “UEA”) 2 including a joint body (a membrane electrode assembly) that includes an electrolyte membrane and electrodes, and a pair of front and rear separators 3 and 3 arranged on both sides in the front-rear direction of the UEA 2. The UEA 2 can also be referred to as a membrane electrode structure. The UEA 2 and the separator 3 are alternately arranged in the front-rear direction. Although not illustrated, a substantially box-shaped case with open front and rear surfaces is arranged so as to surround the cell stacked body 101. The front end surface of the case and the front end unit 102, and the rear end surface of the case and the rear end unit 102 are fastened with bolts, respectively.

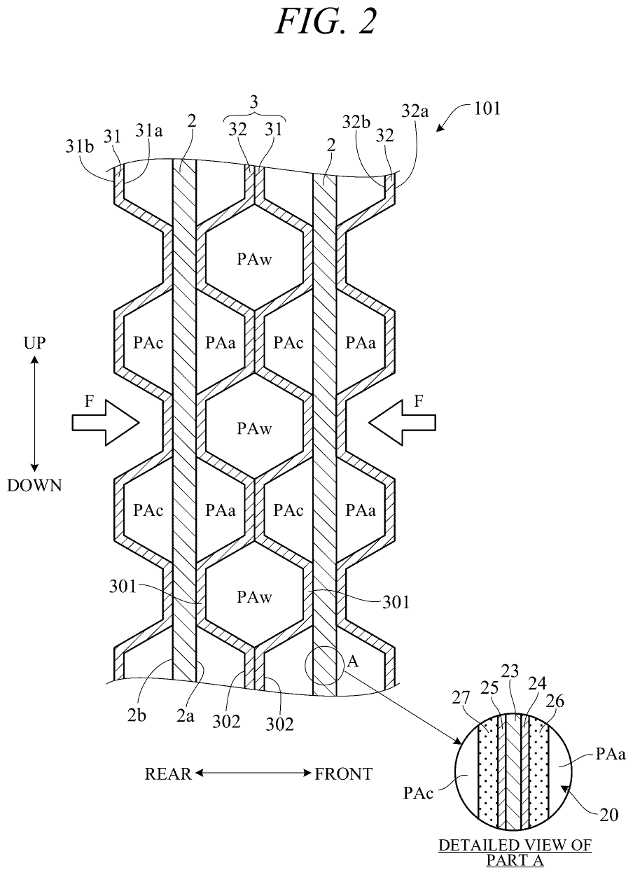

FIG. 2 is a partial cross-sectional view (a cross-sectional view along line II-II in FIG. 1) of the cell stacked body 101. As shown in FIG. 2, the separator 3 has a front plate 31 and a rear plate 32, which are a pair of metal thin plates with a corrugated cross-section. The front plate 31 has a front surface 31a and a rear surface 31b. The rear plate 32 has a front surface 32a and a rear surface 32b. The outer peripheral edges of the front plate 31 and the rear plate 32 are joined by welding or the like, thereby forming the separator 3. The separator 3 uses a conductive material with excellent corrosion resistance, such as stainless steel, titanium, or titanium alloy.

Inside the separator 3 enclosed by the front plate 31 and the rear plate 32, a cooling flow path PAw through which a cooling medium flows is formed, and the power generation surface of the power generation cell 1 is cooled by the flow of the cooling medium. Water can be used as the cooling medium, for example. The separator 3 is formed in an uneven shape by press molding or the like to form a gas flow path between the separator and the UEA 2. More specifically, the front plate 31 and the rear plate 32 have rib portions 301 protruding toward the UEA 2 on the front side and the UEA 2 on the rear side, respectively, and concave portions 302 formed between the pair of rib portions 301 in a concave shape, continuous with the rib portions 301.

The rib portion 301 of the rear plate 32 abuts the front surface 2a of the UEA 2, and the rib portion 301 of the front plate 31 abuts the rear surface 2b of the UEA 2. A compressive load F is applied in the front-rear direction to the cell stacked body 101 during the assembly of the fuel cell stack 100, and in that state, the case and the front and rear end units 102 are fastened. Therefore, after the assembly of the fuel cell stack 100 is completed, the compressive load F on the fuel cell stack 100 is maintained. For this reason, a predetermined surface pressure P0 acts on the UEA 2 in the front-rear direction through the rib portion 301.

Between the rear plate 32 of the separator 3 and the front surface 2a of the UEA 2, an anode flow path PAa through which fuel gas (anode gas) flows is formed by the concave portion 302. Between the front plate 31 of the separator 3 and the rear surface 2b of the UEA 2, a cathode flow path PAc through which oxidant gas (cathode gas) flows is formed by the concave portion 302. Hydrogen gas containing hydrogen can be used as the fuel gas, and air containing oxygen can be used as the oxidant gas.

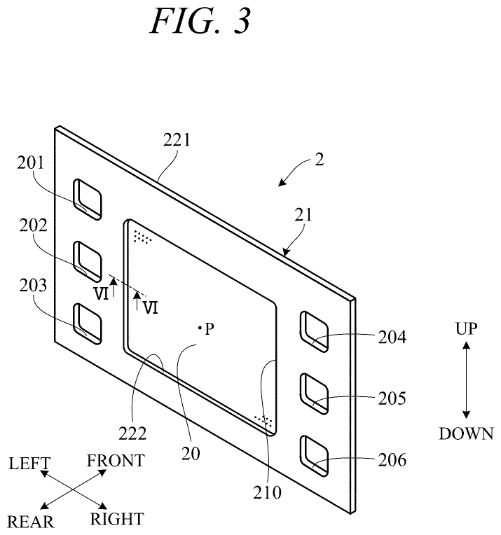

FIG. 3 is a perspective view showing a schematic configuration of the UEA 2. As shown in FIG. 3, the UEA 2 includes a substantially rectangular membrane electrode assembly (hereinafter, referred to as a “MEA”) 20 and a frame 21 with a framed shape that supports the MEA 20. The UEA2 can also be referred to as a membrane electrode structure. As shown in the detailed view of part “A” in FIG. 1, the MEA 20 has an electrolyte membrane 23, an anode electrode provided on a front surface of the electrolyte membrane 23, and a cathode electrode provided on a rear surface of the electrolyte membrane 23.

The anode electrode has an electrode catalyst layer 24 formed on the front surface of the electrolyte membrane 23 and served as a reaction field for electrode reaction, and a gas diffusion layer 26 formed on the front surface of the electrode catalyst layer 24 to spread and supply the fuel gas. Among the electrode catalyst layer 24 and the gas diffusion layer 26, the electrode catalyst layer 24 may be particularly referred to as the anode electrode. An intermediate layer (underlayer) can also be provided between the electrode catalyst layer 24 and the gas diffusion layer 26.

The cathode electrode has an electrode catalyst layer 25 formed on the rear surface of the electrolyte membrane 23 and served as a reaction field for electrode reaction, and a gas diffusion layer 27 formed on the rear surface of the electrode catalyst layer 25 to spread and supply the oxidant gas. Among the electrode catalyst layer 25 and the gas diffusion layer 27, the electrode catalyst layer 25 may be particularly referred to as the cathode electrode. An intermediate layer (underlayer) can also be provided between the electrode catalyst layer 25 and the gas diffusion layer 27.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used. Each of the electrode catalyst layers 24 and 25 includes a catalyst metal that promotes the electrochemical reaction of hydrogen contained in the fuel gas and oxygen contained in the oxidant gas, an electrolyte (such as an ionomer) with proton conductivity, and carbon particles with electronic conductivity. The gas diffusion layers 26 and 27 are composed of conductive members with gas permeability, such as carbon porous bodies.

In the anode electrode (electrode catalyst layer 24), the fuel gas (hydrogen) supplied through the anode flow path PAa and the gas diffusion layer 26 is ionized by an action of a catalyst, passes through the electrolyte membrane 23, and moves to the cathode electrode side. Electrons generated at this time pass through an external circuit and are extracted as electric energy. In the cathode electrode (electrode catalyst layer 25), an oxidant gas (oxygen) supplied via the cathode flow path PAc and the gas diffusion layer 27 reacts with hydrogen ions guided from the anode electrode and electrons moved from the anode electrode to generate water. The generated water gives an appropriate humidity to the electrolyte membrane 23, and excess water is discharged to an outside of the UEA 2 along the gas flow.

The frame 21 in FIG. 3 is a film-like thin plate (film member) with a thickness of 0.1 mm or less, having a substantially rectangular shape, and is made of an insulating resin or rubber. For example, PEN (polyethylene naphthalate) or PPS (polyphenylene sulfide) can be used as the constituent material. In the central portion of the frame 21, a substantially rectangular opening 210 is provided, and the MEA 20 is provided to cover the entire opening 210. The frame 21 has a substantially rectangular outer edge portion 221 and a substantially rectangular inner edge portion 222 inside the outer edge portion 221. The outer edge portion 221 refers to the outer edge of the frame 21 and its surrounding area, and the inner edge portion 222 refers to the inner edge of the frame 21 (the edge of the opening 210) and its surrounding area.

Point P in FIG. 3 is a center point passing through the middle of the opening 210 in the up-down and the left-right directions. On the left side of the opening 210 of the frame 21, three through-holes 201 to 203 penetrating the frame 21 in the front-rear direction are opened in the up-down direction, and on the right side of the opening 210, three through-holes 204 to 206 penetrating the frame 21 in the front-rear direction are opened in the up-down direction.

As shown in FIG. 1, through-holes 311 to 316 penetrating the separator 3 in the front-rear direction are opened at positions corresponding to the through-holes 201 to 206 of the frame 21 in the front and rear separators 3 of the UEA 2. The through-holes 311 to 316 communicate with the through-holes 201 to 206 of the frame 21, respectively. The set of through-holes 201 to 206 and 311 to 316, which communicate with each other, forms flow paths PA1 to PA6 (indicated by arrows for convenience) extending in the front-rear direction through the cell stacked body 101. The flow paths PA1 to PA6 are sometimes referred to as manifolds.

The end units 102 arranged on both front and rear sides of the cell stacked body 101 include terminal plates with conductivity, insulating plates with insulation arranged on the front-rear direction inside of the end plates, and metal end plates arranged on both front-rear sides of the insulating plates. The rear end unit 102 is provided with a plurality of through-holes 102a to 102f that penetrate the end unit 102 in the front-rear direction. The fow paths PA1 to PA6 are connected to external manifolds of the fuel cell stack 100 through the through-holes 102a to 102f.

The flow path PA1 (solid line arrow) extending forward through the through-holes 201 and 311 is a fuel gas supply flow path. The flow path PA6 (solid line arrow) extending rearward through the through-holes 206 and 316 is a fuel gas discharge flow path. The fuel gas supply flow path PA1 and the fuel gas discharge flow path PA6 communicate with the anode flow path PAa (FIG. 2) provided facing the front surface of the MEA 20, and as indicated by the solid line arrow, the fuel gas flows to the right through the anode flow path PAa through the fuel gas supply flow path PA1 and the fuel gas discharge flow path PA6. The communication between the anode flow path PAa and other flow paths PA2 to PA5 is blocked by a seal portion not shown.

The flow path PA4 (dotted line arrow) extending forward through the through-holes 204 and 314 is an oxidant gas supply flow path. The flow path PA3 (dotted line arrow) extending rearward through the through-holes 203 and 313 is an oxidant gas discharge flow path. The oxidant gas supply flow path PA4 and the oxidant gas discharge flow path PA3 communicate with the cathode flow path PAc (FIG. 2) provided facing the rear surface of the MEA 20, and as indicated by the dotted line arrow, the oxidant gas flows to the left through the cathode flow path PAc through the oxidant gas supply flow path PA4 and the oxidant gas discharge flow path PA3. The communication between the cathode flow path PAc and other flow paths PA1, PA2, PA5 and PA6 is blocked by a seal portion not shown.

The flow path PA5 (chain line arrow) extending forward through the through-holes 205 and 315 is a cooling medium supply flow path. The flow path PA2 (chain line arrow) extending rearward through the through-holes 202 and 312 is a cooling medium discharge flow path. The cooling medium supply flow path PA5 and the cooling medium discharge flow path PA2 communicate with the cooling flow path PAw (FIG. 2) provided inside the separator 3, and the cooling medium flows through the cooling flow path PAw through the cooling medium supply flow path PA5 and the cooling medium discharge flow path PA2. The communication between the cooling flow path PAw and other flow paths PA1, PA3, PA4 and PA6 is blocked by a seal portion not shown.

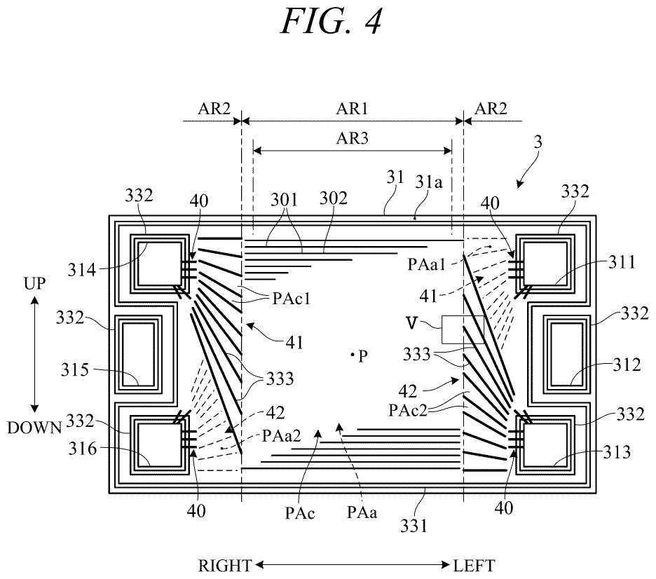

A schematic configuration of the fuel cell stack 100 has been described above. The configuration of the separator 3 will be described in more detail. FIG. 4 is a front view (a view viewed from the front) of the separator 3. That is, FIG. 4 is a view illustrating the surface (the front surface 31a of the front plate 31) of the separator 3 facing the cathode electrode on the rear surface 2b of the UEA 2. A point P in the drawing is a center point of the separator 3.

In FIG. 4, a region AR1 facing the MEA 20 of the UEA 2 is referred to as a central region of the separator 3, and a region AR2 on an outer side of the central region AR1 in the left-right direction is referred to as an end region. As illustrated in FIGS. 2 and 4, in the central region AR1 of the separator 3, although not illustrated in part, a plurality of rib portions 301 (FIG. 2) are provided at equal intervals in the up-down direction over substantially the entire region to protrude forward. A power generation region AR3 is provided inside the central region AR1 in the left-right direction. In the power generation region AR3, power generation is performed by an electrochemical reaction between hydrogen contained in the fuel gas and oxygen contained in the oxidant gas.

Each of the plurality of rib portions 301 extends in the left-right direction, and a concave portion 302 (FIG. 2) is provided between the rib portions 301 and 301 adjacent in the up-down direction. A plurality of cathode flow paths PAc extending in the left-right direction are formed to be substantially parallel to each other between the plurality of concave portions 302 and the MEA 20. Therefore, the rib portion 301 constitutes a partition wall of the cathode flow path PAc. The oxidant gas flows from right to left along the cathode flow path PAc as indicated by arrows in FIG. 4. The cathode flow path PAc does not extend linearly in the left-right direction, but may extend in the left-right direction while meandering in the up-down direction.

As illustrated in FIG. 4, a plurality of sealing bead portions protruding forward toward the frame 21, that is, metal bead seals are provided on the front surface 31a in the end region AR2 of the separator 3 (front plate 31). The plurality of bead portions include an outer bead portion 331 and a plurality of individual bead portions 332.

The plurality of individual bead portions 332 each has a substantially rectangular shape and individually surrounds one of a plurality of through-holes 311 to 316. The outer bead portion 331 extends in the left-right direction above and below the central region AR1 along the upper edge portion and the lower edge portion of the separator 3, and extends in a zigzag shape via the left-right outside of the individual bead portions 332 around the through-holes 311, 313, 314, and 316 and via the left-right inside of the individual bead portions 332 around the through-hole 312 and 315.

In the end region AR2 of the separator 3 (front plate 31), a plurality of guide portions 333 protrude forward from the through-hole 314 to the entire inlet region at the right end (the left end in the drawing) of the cathode flow path PAc and from the entire outlet region at the left end (the right end in the drawing) of the cathode flow path PAc to the through-hole 313. A plurality of tunnel portions 40 crossing the individual bead portions 332 are provided between the through-hole 314 and a space between the guide portions 333 and 333 adjacent in the up-down direction, and between the through-hole 313 and a space between the guide portions 333 and 333 adjacent in the up-down direction.

In the right end region AR2, a connection flow path PAc1 that connects the outlet of the tunnel portion 40 connected to the through-hole 314 and the cathode flow path PAc is formed between the guide portions 333 and 333 adjacent in the up-down direction. In the left end region AR2, a connection flow path PAc2 that connects the cathode flow path PAc and the inlet of the tunnel portion 40 connected to the through-hole 313 is formed between the guide portions 333 and 333 adjacent in the up-down direction. Therefore, the guide portion 333 constitutes a partition wall of the flow path PAc1 and PAc2.

The number of the connection flow paths PAc1 and PAc2 is smaller than the number of the cathode flow paths PAc (concave portions 302). For example, the number of the connection flow paths PAc1 and PAc2 is ½ or less, ⅕ or less to 1/10 or less of the number of the cathode flow paths PAc. Therefore, the cathode flow paths PAc are provided with a higher density than the connection flow paths PAc1 and PAc2. A branching portion 41 that branches the flow of the oxidant gas and guides the flow to the cathode flow path PAc is provided between the connection flow path PAc1 on the right side and the cathode flow path PAc. A merging portion 42 that merges the flows of the oxidant gas and guides the flows to the connection flow path PAc2 is provided between the cathode flow path PAc and the connection flow path PAc2 on the left side.

Although not illustrated, similarly to FIG. 4, the outer bead portion 331, the individual bead portion 332, the tunnel portion 40, the guide portion 33, the rib portion 301, and the concave portion 302 are also provided on a rear surface 32b of the separator 3 (rear plate 32). Then, a plurality of anode flow paths PAa in the up-down direction are formed by the concave portion 302, a connection flow path PAa1 is provided between the through-hole 311 and the anode flow path PAa, and a connection flow path PAa2 is provided between the anode flow path PAa and the through-hole 316. Furthermore, the branching portion 41 is provided between the connection flow path PAa1 and the anode flow path PAa, and the merging portion 42 is provided between the anode flow path PAa and the connection flow path PAa2. The connection flow paths PAc1 and PAa1, and PAc2 and PAa2 in which the branching portion 41 and the merging portion 42 are provided, that is, the flow path between the guide portions 333 and 333 adjacent in the up-down direction may be referred to as an outer flow path.

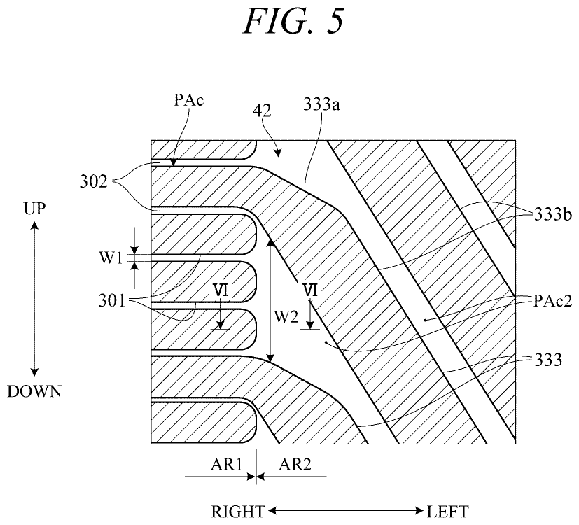

FIG. 5 is an enlarged view of a part V in FIG. 4 illustrating a configuration of the merging portion 42 of the cathode flow path PAc. In FIG. 5, the rib portion 301 and the guide portion 333 are indicated by hatching for convenience. As illustrated in FIG. 5, the guide portion 333 includes a bent portion 333a that is bent leftward and downward from the left end portion of the central region AR1 of the separator 3, and a straight portion 333b that extends substantially linearly leftward and downward from the left end portion of the bent portion 333a.

A plurality of (for example, three) rib portions 301 are included between a pair of bent portions 333a and 333a adjacent in the up-down direction. Therefore, a plurality of cathode flow paths PAc communicate with a single connection flow path PAc2. The inlet of the connection flow path PAc2, that is, the flow path between the pair of bent portions 333a and 333a constitutes the merging portion 42. In other words, the merging portion 42 refers to a range from the end portion of the cathode flow path PAc to a portion of the connection flow path PAc2 where the width is constant.

A width W1 of the cathode flow path is minute and is narrower than a width W2 of the connection flow path PAc2 at the merging portion 42. The width W2 of the connection flow path PAc2 gradually decreases from the merging portion 42 toward the downstream side in a flow direction, that is, toward leftward and downward. In the straight portion 333b, the width W2 of the connection flow path PAc2 is substantially constant.

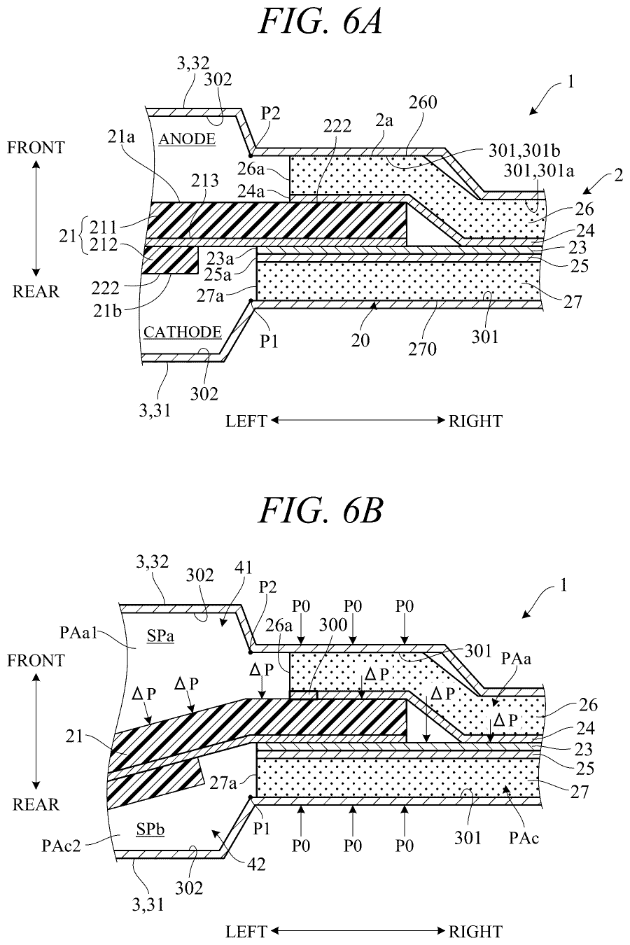

The power generation cell 1 according to the present embodiment is characterized by a configuration of a peripheral portion of the opening 210 of the frame 21 in FIG. 3. This point will be described below. FIG. 6A is a cross-sectional view illustrating a configuration of a main part of the power generation cell 1. This cross-sectional view is a cross-sectional view taken along line VI-VI of FIG. 3, that is, a cross-sectional view illustrating the configuration around the left inner edge portion 222 of the frame 21. The configuration around the inner edge portion 222 is the same over the entire circumference of the inner edge portion 222 along the opening 210. Hereinafter, the right direction in FIG. 4A, that is, a direction (center side) toward the center point P in FIG. 3 may be referred to as an inner direction or an inward, and the right side in FIG. 4A may be referred to as an inner side. In addition, the left direction in FIG. 4A, that is, a direction toward the outer edge portion 221 in FIG. 3 may be referred to as an outer direction or an outward, and the left direction in FIG. 4A may be referred to as an outer side.

FIG. 6A also illustrates the separator 3 (rear plate 32) abutting on the front surface 2a of the UEA 2, more specifically, the front surface 260 of the gas diffusion layer 26, and the separator 3 (front plate 31) abutting on the rear surface 2b of the UEA 2, more specifically, the rear surface 270 of the gas diffusion layer 27. The cross-sectional view of the separator 3 corresponds to the cross-sectional view taken along line VI-VI in FIG. 5.

The separator 3 is provided with the rib portions 301 that abut on each of the front surface 2a and the rear surface 2b of the UEA 2, and concave portions 302 that are recessed in a direction away from each of the front surface 2a and the rear surface 2b of the UEA 2. Although not illustrated, the guide portions 333 of the separator 3 abut on each of the front surface 21a and the rear surface 21b of the frame 21 on the outer side of the MEA 20 (the left side in FIG. 6A). There are no gas diffusion layer 26 and 27 between the guide portion 333 and the front surface 21a of the frame 21 and between the guide portion 333 and the rear surface 21b of the frame 21, and the guide portion 333 is higher in height (a length in the front-rear direction) toward the frame 21 than the rib portion 301.

As illustrated in FIG. 6A, a left end portion 23a (outer end portion) of the electrolyte membrane 23, and a left end portion 25a of the cathode-side electrode catalyst layer 25 and a left end portion 27a of cathode-side the gas diffusion layer 27 are positioned at the same position in the left-right direction. The left end portion 24a of the anode-side electrode catalyst layer 24 and the left end portion 26a of the anode-side gas diffusion layer 26 are positioned a predetermined length to the right (inward) of the left end portion 23a of the electrolyte membrane 23. The positions of the left end portion 24a of the electrode catalyst layer 24 and the left end portion 26a of the gas diffusion layer 26 are identical to each other.

The frame 21 has a front frame 211 and a rear frame 212 which overlap and are joined to each other via an adhesive 213. The inner edge portion 222 of the front frame 211 protrudes to the right (inward) from the inner edge portion 222 of the rear frame 212. Although not illustrated, the positions in the left-right direction of the outer edge portion 221 (FIG. 3) of the front frame 211 and the outer edge portion 221 of the rear frame 212 are identical to each other.

The inner edge portion 222 of the front frame 211, particularly the right end portion of the front frame 211 is interposed between the electrolyte membrane 23 and the anode-side electrode catalyst layer 24. Therefore, the right end portion (inner end portion) of the front frame 211 is positioned to the right of the left end portions 23a, 24a, and 25a of the electrolyte membrane 23 and the electrode catalyst layers 24 and 25. The UEA 2 is manufactured by, for example, the following procedure.

First, the electrode catalyst layer 25 is applied to a surface (front surface) of the cathode-side gas diffusion layer 27. Next, the electrolyte membrane 23 is joined to the surface (front surface) of the electrode catalyst layer 25. Next, the inner edge portion 222 of the front frame 211 is joined to the surface (front surface) of the electrolyte membrane 23 via the adhesive 213. Next, the anode-side gas diffusion layer 26 having a surface applied with the electrode catalyst layer 24 in advance is stacked on the surfaces (front surfaces) of the electrolyte membrane 23 and the front frame 211 while the electrolyte membrane 23 and the electrode catalyst layer 24 are joined. At this time, the left end portions of the anode-side electrode catalyst layer 24 and the gas diffusion layer 26 are bent forward as illustrated in the drawing, and are positioned on the front side by an amount corresponding to the thickness of the front frame 211 from the position before bending. Therefore, a step is provided on the front surface 260 of the gas diffusion layer 26.

The rear plate 32 of the separator 3 is formed in a stepped shape corresponding to the step of the front surface 260. That is, the rear plate 32 has a rib portion 301a that abuts on the front surface 260 of the gas diffusion layer 26 before bending, and a rib portion 301b that abuts on the front surface 260 after bending. The cathode-side gas diffusion layer 27 is not bent, and thus the rib portion 301 of the front plate 31 is not stepped. A surface pressure P0 due to a compressive load F in FIG. 2 acts on the front surface 260 of the anode-side gas diffusion layer 26 and the rear surface 270 of the cathode-side gas diffusion layer 27 via the rib portion 301 (see FIG. 6B). That is, the surface pressure P0 acts to hold the UEA 2 in the front-rear direction.

The position of the left end portion 27a (left end surface) of the cathode-side gas diffusion layer 27 is identical to a position P1 of the left end portion (outer end portion) of the rib portion 301 of the front plate 31 of the separator 3, that is, the start position of the merging portion 42 or slightly rightward of the position P1. The left end portion 26a (left end surface) of the anode-side gas diffusion layer 26 is positioned a predetermined length to the right of the position P1 and a position P2 of the left end portion (outer end portion) of the rib portion 301 on the rear plate 32 of the separator 3, that is, the start position of the merging portion 42. The left end portion 26a of the gas diffusion layer 26 is positioned to the right of the left end portion 27a of the gas diffusion layer 27.

Accordingly, the left end portions 23a, 24a, and 25a of the electrolyte membrane 23 and the electrode catalyst layers 24 and 25 are sandwiched between the front rib portion 301 and the rear rib portion 301 on which the surface pressure P0 acts, with the gas diffusion layers 26 and 27 interposed therebetween without any gap. Therefore, the left end portions 23a, 24a, and 25a of the electrolyte membrane 23 and the electrode catalyst layers 24 and 25 can be firmly held.

In such a power generation cell 1, during the operation of the fuel cell stack 100, the fuel gas is guided to the anode flow path PAa and the connection flow path PAa1 of the concave portion 302 on the front side of the UEA 2. In addition, the oxidant gas is guided to the cathode flow path PAc and the connection flow path PAc2 of the concave portion 302 on the rear side. The pressure of the fuel gas is higher than the pressure of the oxidant gas. Therefore, as illustrated in FIG. 6B, a differential pressure AP acts from a space SPa of the connection flow path PAa1 in the branching portion 41 on the anode side to a space SPc of the connection flow path PAc2 in the merging portion 42 on the cathode side.

Accordingly, the frame 21 (front frame 211) may deflect rearward. However, the gas diffusion layers 26 and 27 are positioned to the right of the positions P1 and P2 at the left end portions of the rib portion 301. Thus, the gas diffusion layers 26 and 27 are firmly held between the rib portions 301 and 301, and deflection of the frame 21 between the gas diffusion layers 26 and 27 can be suppressed. In particular, the left end portion (outer end portion) 26a of the anode-side gas diffusion layer 26 is positioned to the right of the left end portion (outer end portion) 27a of the cathode-side gas diffusion layer 27, so that the frame 21 and the electrode catalyst layer 24 can be maintained in an excellent close contact state.

When the fuel cell stack 100 is used in a cold district or the like, moisture that infiltrates from the left end portion 24a of the electrode catalyst layer 24 may freeze, and ice 300 may exist between the gas diffusion layer 26 and the frame 21. Even when fuel cell stack 100 is started in this state, as illustrated in FIG. 6B, deflection does not occur at the left end portion 26a of the gas diffusion layer 26 where the ice 300 exists. On the other hand, when deflection occurs at the left end portion 26a of the gas diffusion layer 26, the following problem may occur.

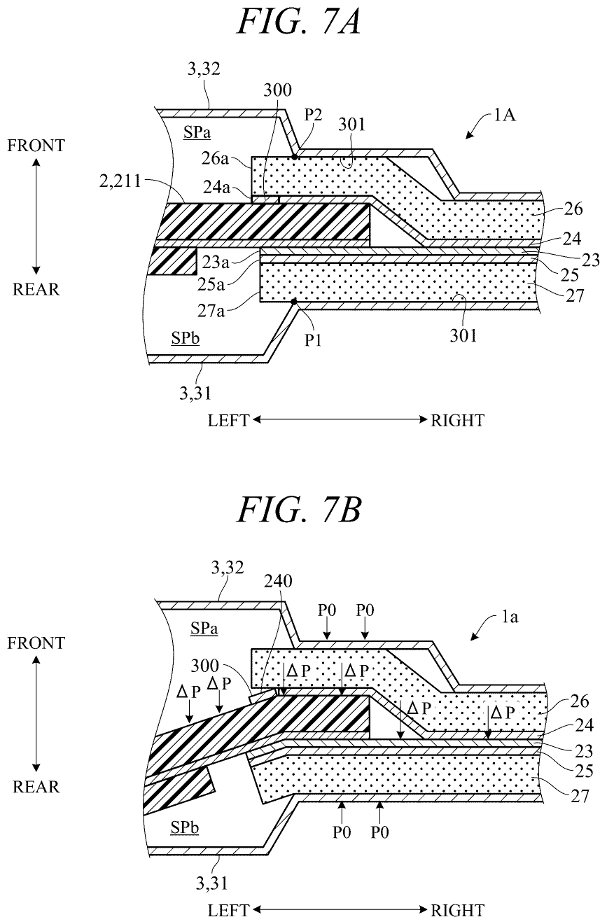

FIG. 7A is a diagram illustrating a reference example of FIG. 6A. In the example of FIG. 7A, the left end portion 23a of electrolyte membrane 23, the left end portion 25a of the cathode-side electrode catalyst layer 25, and the left end portion 27a of the cathode-side gas diffusion layer 27 protrude leftward (outward) from the position P1 of the left end portion of the rib portion 301 of the separator 3 (front plate 31). In addition, the left end portion 24a of the anode-side electrode catalyst layer 24 and the left end portion 26a of the anode-side gas diffusion layer 26 protrude leftward (outward) from the position P2 of the left end portion of the rib portion 301 of the separator 3 (rear plate 32). The positions of the left end portions 23a, 24a, 25a, 26a, and 27a of the elements of the UEA 2 are identical to or substantially identical to each other.

FIG. 7A illustrates a sub-zero state where the ice 300 exists between the gas diffusion layer 26 and the frame 21. When the fuel cell stack 100 is started from this state, the frame 21 may deflect as illustrated in FIG. 7B. Accordingly, a part (referred to as a detached material 240) of the electrode catalyst layer 24 may be pulled by ice 300 and detached from the gas diffusion layer 26. When the ice 300 melts in this state, the detached material 240 is guided to a drain flow path of the fuel cell stack 100 together with water. The drain flow path is a flow path for discharging excess water generated in the fuel cell stack to the outside. A filter is provided in the middle of the drain flow path. Therefore, when the detached material 240 reaches the drain flow path, the filter may be clogged.

In this regard, in the present embodiment, as illustrated in FIG. 6B, even when the differential pressure AP acts, the frame 21 does not deflect between the gas diffusion layers 26 and 27, and the electrolyte membrane 23 and the electrode catalyst layer 24 can be maintained in a close contact state. Therefore, even in a case where ice adheres to the end portion of the electrode catalyst layer 24 in use in a cold district, it is possible to prevent a part of the electrode catalyst layer 24 from falling off due to the ice.

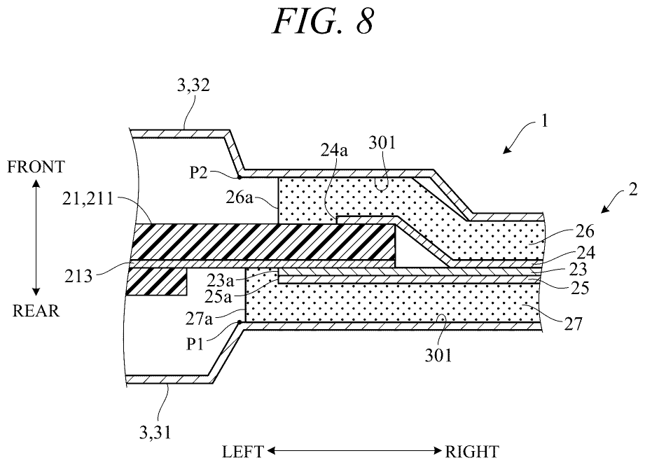

FIG. 8 is a diagram illustrating a modification of FIG. 6A. FIG. 8 is different from FIG. 6A in positions of the left end portions 23a, 24a, and 25a of the electrolyte membrane 23 and the electrode catalyst layers 24 and 25. That is, in FIG. 8, the left end portion 23a of the electrolyte membrane 23 and the left end portion 25a of the cathode-side electrode catalyst layer 25 are positioned to the right of the left end portion 27a of the gas diffusion layer 27. In addition, the left end portion 24a of the anode-side electrode catalyst layer 24 is positioned to the right of the left end portion 26a of the gas diffusion layer 26. Similarly to FIG. 6A, the left end portions 26a and 27a of the gas diffusion layers 26 and 27 are positioned to the right of the positions P1 and P2 of the left end portions of the rib portion 301, and the left end portion 26a of the anode-side gas diffusion layer 26 is positioned to the right of the left end portion 27a of the cathode-side gas diffusion layer 27.

The separator 3 disposed on both sides of the gas diffusion layers 26 and 27 in the front-rear direction contains iron as a component. Therefore, generated water or condensed water generated by the electrochemical reaction between the fuel gas and the oxidant gas is accumulated in the anode flow path PAa or the cathode flow path PAc, and iron ions may dissolve into the accumulated water. Since the iron ions cause deterioration of the electrolyte membrane 23, it is preferable to prevent moisture containing iron ions from infiltrating the electrolyte membrane 23. In this regard, in the example of FIG. 8, the electrode catalyst layers 24 and 25 containing ionomer are sandwiched between the rib portions 301 of the front and rear separators 3 with the gas diffusion layers 26 and 27 interposed therebetween, in a state where the electrode catalyst layers 24 and 25 are positioned on the right of the left end portions 26a and 27a of the gas diffusion layers 26 and 27. Therefore, the electrode catalyst layers 24 and 25 are not exposed to the left side (outside) of the gas diffusion layers 26 and 27.

As described above, the electrode catalyst layers 24 and 25 serving as an infiltration path of iron ions are not exposed, so that the infiltration path of iron ions is blocked. Accordingly, it is possible to prevent moisture containing iron ions from infiltrating the inside through boundary surfaces between the gas diffusion layers 26 and 27 and the frame 21 (front frame 211). In particular, since the gas diffusion layers 26 and 27 contain carbon having water-repellent properties, it is possible to satisfactorily prevent moisture containing iron ions from infiltrating through the boundary surfaces between the gas diffusion layers 26 and 27 and the frame 21.

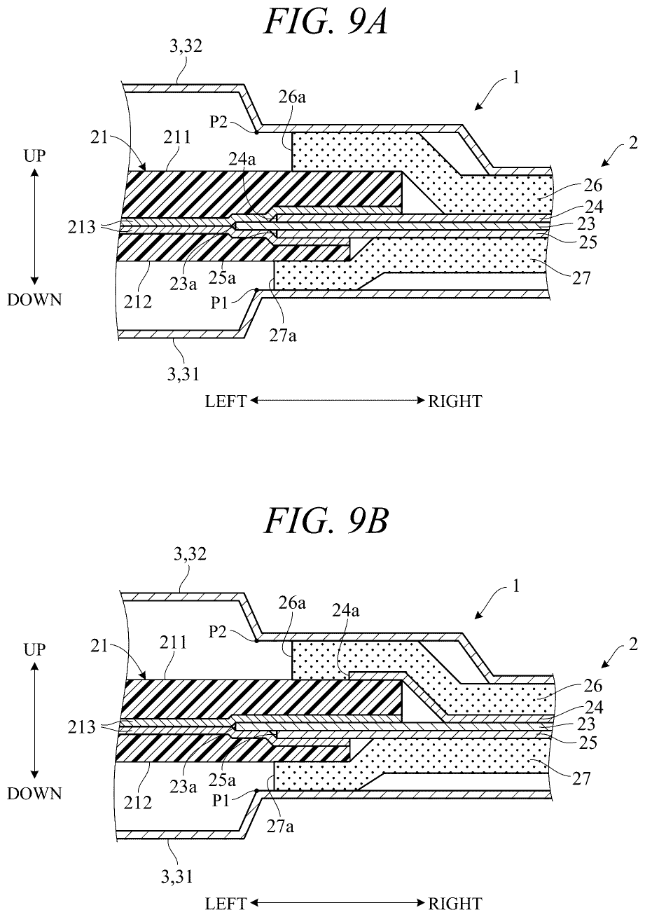

FIGS. 9A and 9B are diagrams illustrating further modifications of FIG. 6A. In FIGS. 9A and 9B, the rear frame 212 extends rightward from that in FIG. 6A, and the front frame 211 and the rear frame 212 are sandwiched between the gas diffusion layers 26 and 27. Further, in FIG. 9A, the electrolyte membrane 23 and the electrode catalyst layers 24 and 25 are sandwiched between the front frame 211 and the rear frame 212. On the other hand, in FIG. 9B, the electrolyte membrane 23 and the cathode-side electrode catalyst layer 25 are sandwiched between front the frame 211 and the rear frame 212, and the anode-side electrode catalyst layer 24 is sandwiched between the front frame 211 and the gas diffusion layer 26.

In both FIGS. 9A and 9B, the left end portions 26a and 27a of the gas diffusion layers 26 and 27 are positioned to the right of the positions P1 and P2 of the left end portions of the rib portion 301, and the left end portion 26a of the anode-side gas diffusion layer 26 is positioned to the right of the left end portion 27a of the cathode-side gas diffusion layer 27. In addition, the left end portions 23a, 24a, and 25a of the electrolyte membrane 23 and the electrode catalyst layers 24 and 25 are not exposed to the gas flow paths PAa and PAc.

According to the present embodiment, the following operations and effects can be achieved.
(1) The power generation cell 1 includes: the UEA 2 as a membrane electrode structure that includes the MEA 20, and the frame 21 provided with the opening 210 covered with the MEA 20 and supporting a peripheral edge portion of the MEA 20; and the separators 3 and 3 that are disposed to face the front surface 2a and the rear surface 2b of the UEA 2, respectively (FIGS. 1 and 3). The MEA 20 includes the electrolyte membrane 23, the electrode catalyst layers 24 and 25 that are disposed in close contact with the front surface and the rear surface of the electrolyte membrane 23, respectively, and the gas diffusion layers 26 and 27 that are disposed between the electrode catalyst layer 24 and the separator 3 and between the electrode catalyst layer 25 and the separator 3, respectively (FIG. 2). The rear plate 32 of the separator 3 has a plurality of rib portions 301 that protrude toward the MEA 20, extend substantially parallel to each other, and form partition walls of a plurality of power generation flow paths (anode flow paths PAa) of a fuel gas (FIG. 2). The front plate 31 of the separator 3 has a plurality of rib portions 301 that protrude toward the MEA 20, extend substantially parallel to each other, and form partition walls of a plurality of power generation flow paths (cathode flow paths PAc) of an oxidant gas having a lower pressure than the fuel gas (FIG. 2). The left end portion 26a (outer end portion) of the anode-side gas diffusion layer 26 along a flow direction of the fuel gas is positioned on the right side (inner side), which is a center side of the opening 210, with respect to the left end portion 27a (outer end portion) of the cathode-side gas diffusion layer 27 along a flow direction of the oxidant gas, and is positioned on the right side (inner side) with respect to the position P1 of the left end portion of the cathode-side rib portion 301 (FIG. 6A).

With this configuration, in a case where the differential pressure AP of the gas acts on the UEA 2, the frame 21 does not deflect between the gas diffusion layers 26 and 27, so that the frame 21 and the anode-side electrode catalyst layer 24 can be maintained in a close contact state. Accordingly, even in a case where the fuel cell is started in a state where ice adheres to the end portion of the anode-side gas diffusion layer 26, it is possible to prevent a part of the MEA 20 (the end portion of the electrode catalyst layer 24) from being detached together with the ice 300. As a result, it is possible to prevent clogging of the filter of the drain path.
(2) The left end portion 26a of the anode-side gas diffusion layer 26 is positioned further on the right side (inner side) of the position P2 of the left end portion of the rib portion 301 on an anode side (FIG. 6A). Accordingly, the differential pressure AP does not act on the gas diffusion layer 26, so that the gas diffusion layer 27 does not deflect, and the frame 21 and electrode catalyst layer 24 can be maintained in an excellent close contact state.
(3) The separator 3 (front plate 31) has a plurality of guide portions 333 provided on the upstream side and the downstream side of the rib portion 301 in the flow direction of the oxidant gas (FIG. 4). A width of a gap (gas flow path PAa, PAc) between a pair of adjacent rib portions 301 and 301 is narrower than a width of a gap (connection flow path PAa1, PAa2, PAc1, PAc2) between a pair of adjacent guide portions 333 and 333 (FIGS. 4 and 5). According to this configuration, the guide portion 333 functions as a rib at the branching portion 41 and the merging portion 42 for gas, but the width between the guide portions 333 and 333 is wide, and the density of the ribs by the guide portions 333 is smaller than the density of the rib portions 301. Therefore, the frame 21 easily deflects at the branching portion 41 and the merging portion 42. In this regard, in the present embodiment, as described above, the left end portion 26a of the gas diffusion layer 26 is positioned on the right side of the left end portion 27a of the gas diffusion layer 27, and is positioned on the right side of the position P1 of the left end portion of the rib portion 301, so that the deflection of the frame 21 between the gas diffusion layers 26 and 27 can be satisfactorily prevented.
(4) The left end portion 24a (outer end portion) of the anode-side electrode catalyst layer 24 is positioned on the right side (inner side) of the left end portion 26a (outer end portion) of the anode-side gas diffusion layer 26 (FIGS. 8, 9A and 9B). The left end portion 25a (outer end portion) of the cathode-side electrode catalyst layer 25 is positioned on the right side (inner side) of the left end portion 27a (left end portion) of the cathode-side gas diffusion layer 27 (FIGS. 8, 9A and 9B). Accordingly, the electrode catalyst layers 24 and 25 are not exposed to the gas flow paths PAa and PAc, and moisture containing iron ions can be prevented from infiltrating the electrolyte membrane 23 through the electrode catalyst layers 24 and 25.

The above embodiments can be modified into various forms. Hereinafter, some modifications will be described. In the above embodiment, the rear plate 32 of the separator 3 is arranged as a first separator facing the front surface 2a (a first surface) of the UEA 2 as a membrane electrode structure, and the front plate 31 of the separator 3 is arranged as a second separator facing the rear surface 2b (a second surface) of the UEA 2. However, the configuration of the first and second separators is not limited to the above configuration. That is, as long as the first separator includes a plurality of first ribs (rib portions 301) that protrude toward the UEA 2 and form partition walls of a plurality of power generation flow paths for a first gas (e.g., fuel gas) extending substantially parallel to each other, its configuration may take any form. As long as the second separator includes a plurality of second ribs (rib portions 301) that protrude toward the UEA 2 and form partition walls of a plurality of power generation flow paths for a second gas (e.g., oxidant gas) extending substantially parallel to each other, its configuration may take any form.

In the above embodiment, the MEA 20 is configured by the electrolyte membrane 23, the electrode catalyst layer 24 (a first electrode catalyst layer) and the electrode catalyst layer 25 (a second electrode catalyst layer) closely arranged on the front surface (one surface) and rear surface (another surface) of the electrolyte membrane 23, and the gas diffusion layer 26 (a first gas diffusion layer) and the gas diffusion layer 27 (a second gas diffusion layer). In this connection, as long as an end condition in which the end of the first gas diffusion layer along the flow direction of the first gas (e.g., fuel gas) is positioned on an inner side (toward the center of the opening 210 of the frame 21 as a frame member) compared to the end of the second gas diffusion layer along the flow direction of the second gas (e.g., oxidant gas), and is also positioned on an inner side of the end of the second ribs, is satisfied, the configuration of the MEA 20 may be any configuration.

In the above embodiment, a plurality of guide portions 333 (outside ribs) are provided at the branching portion 41 and the merging portion 42, which are located on the upstream side and downstream side of the rib portion 301 in the flow direction of the oxidant gas, and the above end condition is satisfied on both the upstream and downstream sides. However, the above end condition may be also satisfied on at least one of the upstream and downstream sides. Although in the above embodiment, the guide portion 333 is configured to have the bent portion 333a and the straight portion 333b, the configuration of an outside rib is not limited to the above configuration. In the above embodiment, the fuel gas is used as a first gas and the oxidant gas as a second gas. However, the configuration of the first gas and the second gas, where the second gas is at a lower pressure than the first gas, is not limited to the above configuration.

In the above embodiment, an example of applying the fuel cell stack 100 to a vehicle is described. However, the fuel cell stack with the power generation cell of the present invention can also be applied to various industrial machines in addition to a moving body other than a vehicle such as an aircraft or a boat, a robot, and the like.

The above embodiment can be combined as desired with one or more of the above modifications. The modifications can also be combined with one another.

According to the present invention, even if a fuel cell is started with ice adhering to an end of a gas diffusion layer, it is possible to prevent a part of a membrane electrode assembly from peeling off together with the ice.

Above, while the present invention has been described with reference to the preferred embodiments thereof, it will be understood, by those skilled in the art, that various changes and modifications may be made thereto without departing from the scope of the appended claims.

What is claimed is:

1. A power generation cell comprising:
a membrane electrode structure including a membrane electrode assembly, and a frame member provided with an opening covered by the membrane electrode assembly and supporting a peripheral edge portion of the membrane electrode assembly; and
a first separator and a second separator disposed facing a first surface and a second surface on an opposite side of the first surface of the membrane electrode structure, respectively, wherein
the membrane electrode assembly includes an electrolyte membrane, a first electrode catalyst layer and a second electrode catalyst layer disposed in close contact with one surface and another surface of the electrolyte membrane, respectively, and a first gas diffusion layer and a second gas diffusion layer disposed between the first electrode catalyst layer and the first separator and between the second electrode catalyst layer and the second separator,
the first separator includes a plurality of first ribs protruding toward the membrane electrode assembly and extending substantially parallel to each other, the plurality of ribs forming partition walls for a plurality of power generation flow paths for a first gas,
the second separator includes a plurality of second ribs protruding toward the membrane electrode assembly and extending substantially parallel to each other, the plurality of ribs forming partition walls for a plurality of power generation flow paths for a second gas having a lower pressure than the first gas, and
an end of the first gas diffusion layer along a flow direction of the first gas is positioned on an inner side closer to a center of the opening, compared to an end of the second gas diffusion layer along a flow direction of the second gas, and is positioned on the inner side of ends of the plurality of second ribs.

2. The power generation cell according to claim 1, wherein
the end of the first gas diffusion layer is further positioned on the inner side of ends of the plurality of first ribs.

3. The power generation cell according to claim 1, wherein
the second separator includes a plurality of outside ribs provided on an upstream side or a downstream side of the plurality of second ribs in the flow direction of the second gas, and
a width of a gap between a pair of adjacent second ribs among the plurality of second ribs is narrower than a width of a gap between a pair of adjacent outside ribs among the plurality of outside ribs.

4. The power generation cell according to claim 3, wherein
an outer flow path is provided between the pair of adjacent outside ribs, and
a merging portion where the plurality of power generation flow paths merge into the outer flow path or a branching portion where the outer flow path branches into the plurality of power generation flow paths, is provided between the outer flow path and the plurality of power generation flow paths.

5. The power generation cell according to claim 1, wherein
an end of the first electrode catalyst layer along the flow direction of the first gas is positioned at the same location as the end of the first gas diffusion layer, and
an end of the second electrode catalyst layer along the flow direction of the second gas is positioned at the same location as an end of the electrolyte membrane or the end of the second gas diffusion layer.

6. The power generation cell according to claim 1, wherein
an end of the first electrode catalyst layer is positioned on the inner side of the end of the first gas diffusion layer, and
an end of the second electrode catalyst layer is positioned on the inner side of the end of the second gas diffusion layer.
